(19) United States
(12) Patent Application Publication
(10) Pub. No.: US 2026/0349950 A1
(43) Pub. Date: Nov. 5, 2026

(54) BRIDGE CHIP AND OPERATING METHOD THEREOF

(71) Applicant: ASMedia Technology Inc., New Taipei City (TW)

(72) Inventor: Chun-Jung Hsu, New Taipei City (TW)

(73) Assignee: ASMedia Technology Inc., New Taipei City (TW)

(21) Appl. No.: 19/209,772

(22) Filed: May 15, 2025

(30) Foreign Application Priority Data
May 2, 2025 (TW) 114116660

(51) Int. Cl. G06F 13/40

(52) U.S. Cl. CPC G06F 13/4027; G06F 2213/40

(57) ABSTRACT

A bridge chip and an operating method thereof are provided. The bridge chip includes an artificial intelligence controller and a bridge control circuit. The bridge control circuit is coupled to the artificial intelligence controller. When the bridge chip is connected to a connection port of a computing device, whether the bridge control circuit supports a specific communication protocol for connection is confirmed by the computing device. When the computing device confirms that the bridge control circuit supports the specific communication protocol for connection, the bridge chip is initialized by the computing device, and the computing device determines whether to perform data transmission with the artificial intelligence controller.

### CROSS-REFERENCE TO RELATED APPLICATION

This application claims the priority benefit of Taiwan application serial no. 114116660, filed on May 2, 2025. The entirety of the above-mentioned patent application is hereby incorporated by reference herein and made a part of this specification.

### BACKGROUND

### Technical Field

The disclosure relates to a chip, and in particular relates to a bridge chip and an operating method thereof.

### DESCRIPTION OF RELATED ART

Currently, artificial intelligence accelerator devices typically require the design of multiple chips to achieve high-speed signal (data) transmission between computing devices, in order to implement artificial intelligence computing acceleration functions. Consequently, conventional circuit designs present related issues such as larger device dimensions, higher component costs, greater circuit substrate layout area, and increased system design complexity.

### SUMMARY

A bridge chip and an operating method thereof are provided in the disclosure, in which an artificial intelligence controller and a bridge control circuit may be integrated into a single chip to facilitate the transmission operation of artificial intelligence computing data.

The bridge chip of the disclosure includes an artificial intelligence controller and a bridge control circuit. The bridge control circuit is coupled to the artificial intelligence controller. When the bridge chip is connected to a connection port of a computing device, whether the bridge control circuit supports a specific communication protocol for connection is confirmed by the computing device. When the computing device confirms that the bridge control circuit supports the specific communication protocol for connection, the bridge chip is initialized by the computing device, and the computing device determines whether to perform data transmission with the artificial intelligence controller.

The operating method of the disclosure is applicable to the bridge chip. The bridge chip includes an artificial intelligence controller and a bridge control circuit. The operating method includes the following operation. When the bridge chip is connected to a connection port of a computing device, whether the bridge control circuit supports a specific communication protocol for connection is confirmed through the computing device. When the computing device confirms that the bridge control circuit supports the specific communication protocol for connection, the bridge chip is initialized by the computing device. Whether to perform data transmission with the artificial intelligence controller is determined through the computing device.

Based on the above, the bridge chip and the operating method thereof of the disclosure may perform the transmission operation of artificial intelligence computing data through a single chip integrating an artificial intelligence controller and a bridge control circuit.

In order to make the above-mentioned features and advantages of the disclosure comprehensible, embodiments accompanied with drawings are described in detail below.

### BRIEF DESCRIPTION OF THE DRAWINGS

FIG. 1 is a schematic diagram of a bridge chip and a computing device of an embodiment of the disclosure.

FIG. 2 is a flowchart of an operating method of a bridge chip of an embodiment of the disclosure.

FIG. 3 is a schematic diagram of a bridge chip and a computing device of another embodiment of the disclosure.

FIG. 4 is a flowchart of an operating method of a bridge chip of another embodiment of the disclosure.

FIG. 5 is a schematic diagram of a bridge chip and a computing device of another embodiment of the disclosure.

FIG. 6 is a flowchart of an operating method of a bridge chip of another embodiment of the disclosure.

FIG. 7 is a schematic diagram of a bridge chip according to another embodiment of the disclosure.

### DETAILED DESCRIPTION OF DISCLOSED EMBODIMENTS

In order to make the content of the disclosure easier to understand, the following specific embodiments are illustrated as examples of the actual implementation of the disclosure. In addition, wherever possible, elements/components/steps with the same reference numerals in the drawings and embodiments represent the same or similar parts.

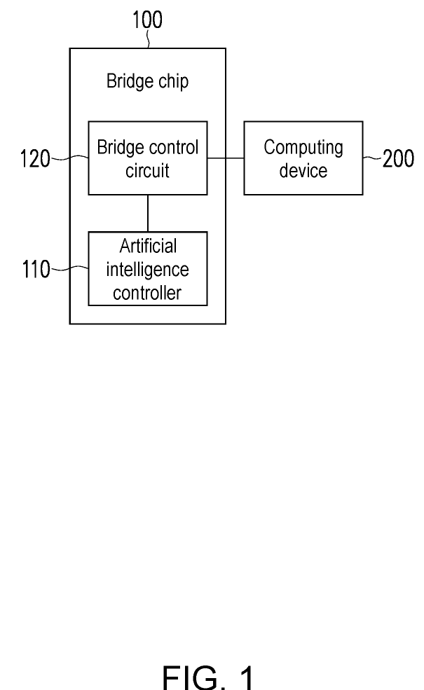

FIG. 1 is a schematic diagram of a bridge chip and a computing device of an embodiment of the disclosure. Referring to FIG. 1, the bridge chip 100 includes an artificial intelligence (AI) controller 110 and a bridge control circuit 120. The artificial intelligence controller 110 is coupled to the bridge control circuit 120. The bridge control circuit 120 of the bridge chip 100 may be coupled to a connection port of the computing device 200. In this embodiment, the bridge chip 100 may be disposed in an artificial intelligence accelerator device and configured to provide (additional) computing resources to the computing device 200 so that the computing device 200 may implement artificial intelligence computing acceleration.

For example, the artificial intelligence accelerator device may include an application-specific integrated circuit (ASIC), a graphics processing unit (GPU), a field-programmable gate array (FPGA), a neural processing unit (NPU), or an image signal processor (ISP) as computing resources for artificial intelligence computing, but the disclosure is not limited thereto. In addition, the computing device 200 may be, for example, a desktop computer, a laptop, a tablet or other types of computer devices, and the computing device 200 is configured to execute an artificial intelligence model to perform artificial intelligence computing accordingly. In this embodiment, the artificial intelligence accelerator device equipped with the bridge chip 100 may be connected to the computing device 200 to provide artificial intelligence computing acceleration functions.

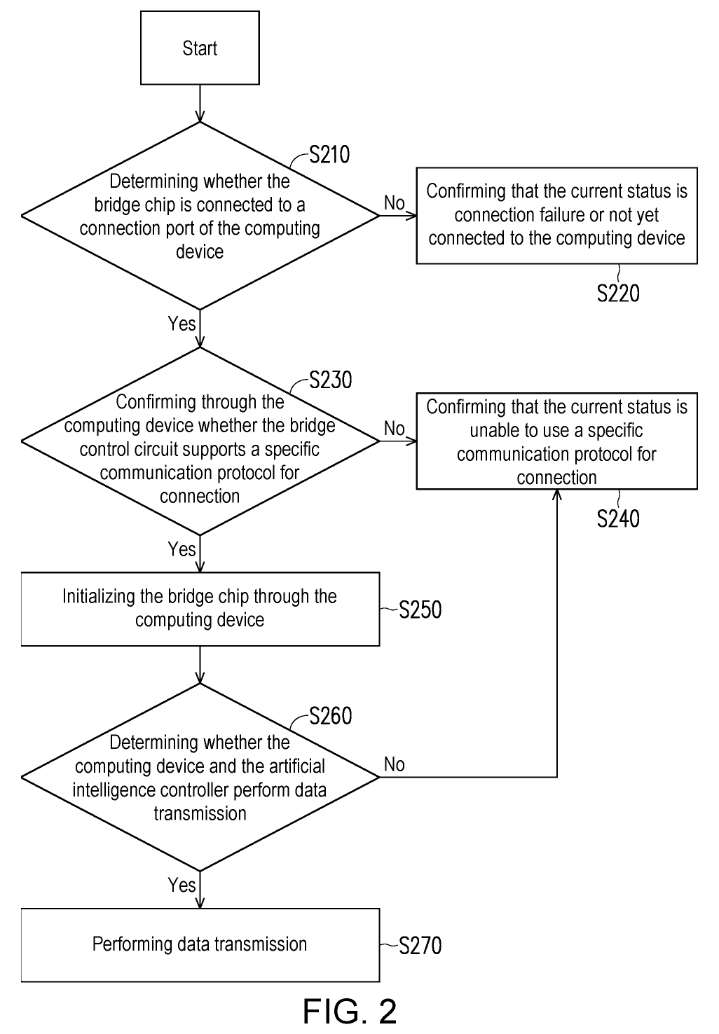

FIG. 2 is a flowchart of an operating method of a bridge chip of an embodiment of the disclosure. Referring to FIGS. 1 and 2 , the bridge chip 100 and the computing device 200 may perform the following steps S210 to S270. In step S210, the bridge chip 100 may determine whether it is connected to a connection port of the computing device 200. In this embodiment, the connection port may be a connection port supporting high-speed signal transmission. If it is determined as "no", in step S220, the bridge chip 100 may confirm that the current status is connection failure or not yet connected to the computing device. If it is determined as "yes", in step S230, whether the bridge control circuit 120 supports a specific communication protocol for connection may be confirmed by the computing device 200. In this embodiment, the specific communication protocol is a high-speed signal transmission protocol. If it is determined as "no", in step S240, the computing device 200 may confirm that the current status is unable to use the specific communication protocol for connection. If it is determined as "yes", in step S250, the computing device 200 may initialize the bridge chip 100 (e.g., configuring relevant parameters such as bandwidth allocation for data transmission and transmission speed).

In step S260, the computing device 200 may determine whether to perform data transmission with the artificial intelligence controller 110. In this embodiment, the computing device 200 may determine whether high-speed data transmission with the artificial intelligence controller 110 is possible. If it is determined as "no", in step S240, the computing device 200 may confirm that the current status is unable to use the specific communication protocol for connection. If it is determined as "yes", in step S270, data transmission may be performed between the bridge chip 100 and the computing device 200. In this embodiment, the bridge chip 100 and the computing device 200 may perform the transmission operation of the artificial intelligence computing data. Therefore, the bridge chip 100 and the operating method thereof of the present embodiment may perform the transmission operation of artificial intelligence computing data through a single chip architecture integrating the artificial intelligence controller 110 and the bridge control circuit 120. Furthermore, since the artificial intelligence controller 110 and the bridge control circuit 120 are integrated into a single chip architecture, this effectively reduces the time required for the bridge control circuit 120 to connect to and identify the downstream artificial intelligence controller 110.

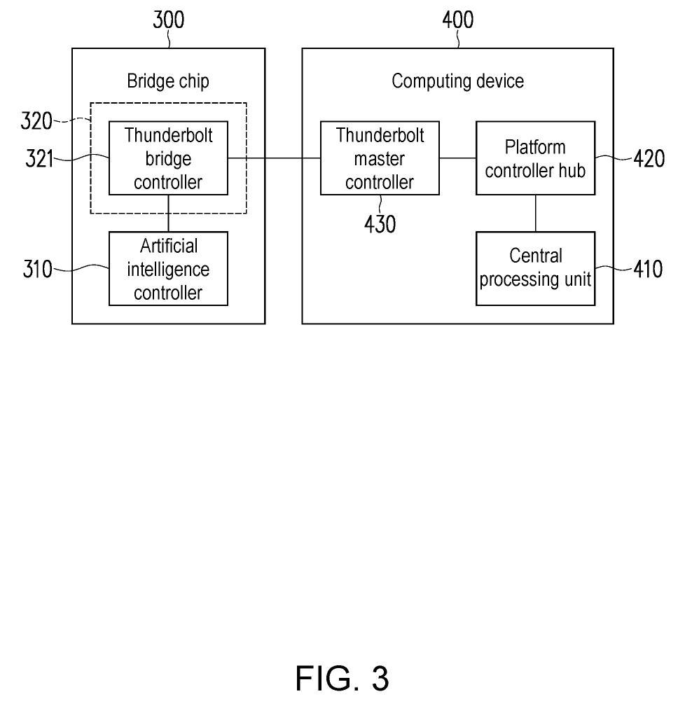

FIG. 3 is a schematic diagram of a bridge chip and a computing device of another embodiment of the disclosure. Referring to FIG. 3, the bridge chip of the disclosure may also implement the architecture shown in FIG. 3. In this embodiment, the bridge chip 300 includes an artificial intelligence controller 310 and a bridge control circuit 320. The bridge control circuit 320 includes a Thunderbolt bridge controller 321. The artificial intelligence controller 310 is coupled to the Thunderbolt bridge controller 321. In this embodiment, the computing device 400 includes a central processing unit (CPU) 410, a platform controller hub (PCH) 420, and a Thunderbolt master controller 430. The platform controller hub 420 is coupled to the central processing unit 410 and the Thunderbolt master controller 430. In this embodiment, the Thunderbolt bridge controller 321 may be connected to the Thunderbolt connection port of the computing device 300 through a Thunderbolt connector to couple to the Thunderbolt master controller 430. In this embodiment, the artificial intelligence controller 310 may be configured to perform the transmission operation of the artificial intelligence computing data with the Thunderbolt master controller 430 of the computing device 400 through the Thunderbolt bridge controller 321.

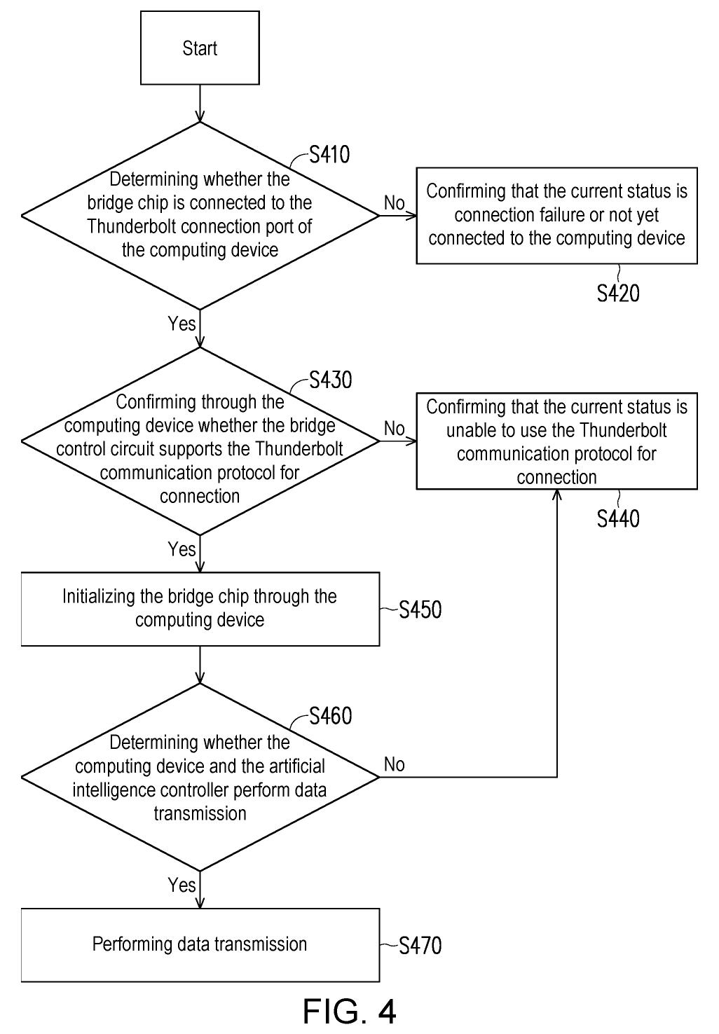

FIG. 4 is a flowchart of an operating method of a bridge chip of another embodiment of the disclosure. Referring to FIGS. 3 and 4 , the bridge chip 300 and the computing device 400 may perform the following steps S410 to S470. In step S410, the bridge chip 300 may determine whether it is connected to the Thunderbolt connection port of the computing device 400. If it is determined as "no", in step S420, the bridge chip 300 may confirm that the current status is connection failure or not yet connected to the computing device. If it is determined as "yes", in step S430, whether the Thunderbolt bridge controller 321 supports the Thunderbolt communication protocol for connection may be confirmed by the Thunderbolt master controller 430 of the computing device 400. If it is determined as "no", in step S440, the Thunderbolt master controller 430 may confirm that the current status is unable to use the specific communication protocol for connection. If it is determined as "yes", in step S450, the Thunderbolt master controller 430 of the computing device 400 may initialize the bridge chip 300.

In step S460, the Thunderbolt master controller 430 of the computing device 400 may determine whether to perform data transmission with the artificial intelligence controller 310. In this embodiment, the Thunderbolt master controller 430 of the computing device 400 may determine whether high-speed data transmission with the artificial intelligence controller 310 is possible. If it is determined as "no", in step S440, the Thunderbolt master controller 430 of the computing device 400 may confirm that that the current status is unable to use the specific communication protocol for connection. If it is determined as "yes", in step S470, data transmission may be performed between the bridge chip 300 and the computing device 400. In this embodiment, the bridge chip 300 and the computing device 400 may perform the transmission operation of the artificial intelligence computing data. Therefore, the bridge chip 300 and the operating method thereof of the present embodiment may perform a Thunderbolt transmission operation through a single chip architecture integrating the artificial intelligence controller 310 and the Thunderbolt bridge controller 321. Furthermore, since the artificial intelligence controller 310 and the Thunderbolt bridge controller 321 are integrated into a single chip architecture, this effectively reduces the time required for the Thunderbolt bridge controller 321 to connect to and identify the downstream artificial intelligence controller 310.

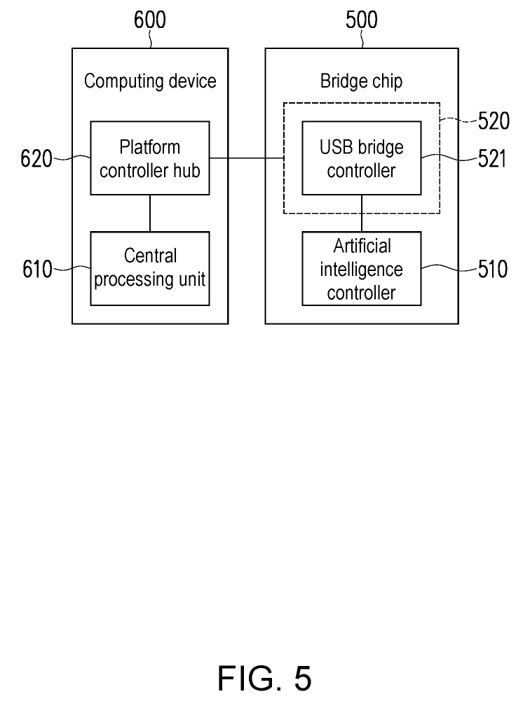

FIG. 5 is a schematic diagram of a bridge chip and a computing device of another embodiment of the disclosure. Referring to FIG. 5, the bridge chip of the disclosure may also implement the architecture shown in FIG. 5. In this embodiment, the bridge chip 500 includes an artificial intelligence controller 510 and a bridge control circuit 520. The bridge control circuit 520 includes a universal serial bus (USB) bridge controller 521. The artificial intelligence controller 510 is coupled to the USB bridge controller 521. In this embodiment, the computing device 600 includes a central processing unit 610 and a platform controller hub 620. In one embodiment, the computing device 600 may also implement the circuit architecture of the computing device 400 of the embodiment of FIG. 3. In this embodiment, the platform controller hub 620 is coupled to the central processing unit 610. In this embodiment, the USB bridge controller 521 may be connected to the USB connection port of the computing device 600 through a USB connector to couple to the platform controller hub 620. In this embodiment, the artificial intelligence controller 510 may be configured to perform the transmission operation of the artificial intelligence computing data with the platform controller hub 620 of the computing device 600 through the USB bridge controller 521.

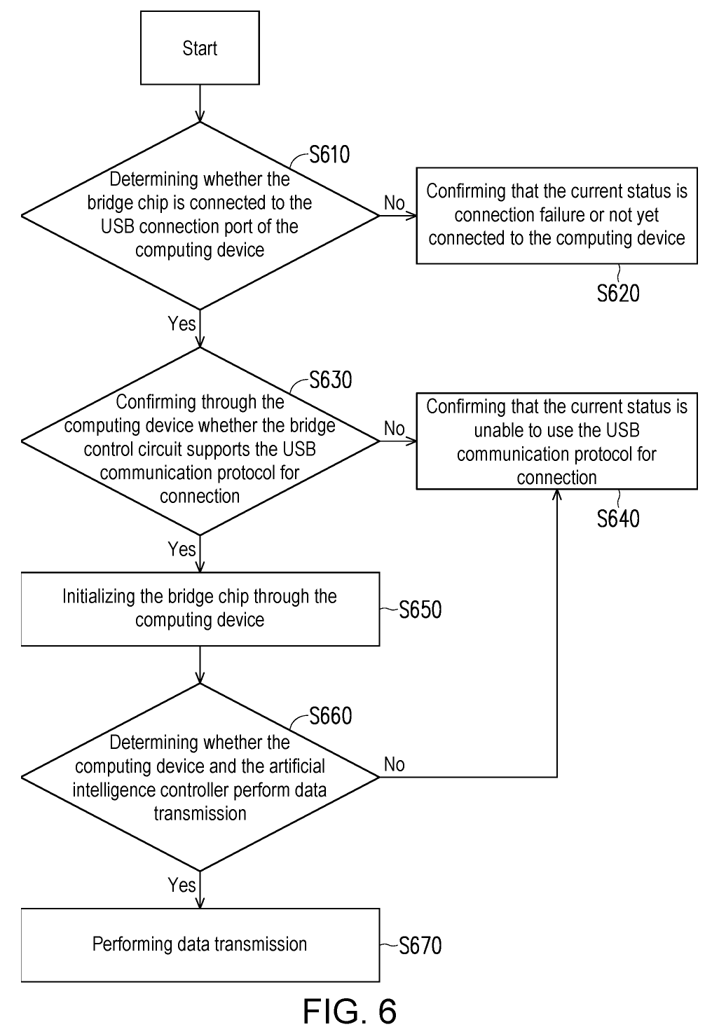

FIG. 6 is a flowchart of an operating method of a bridge chip of another embodiment of the disclosure. Referring to FIGS. 5 and 6 , the bridge chip 500 and the computing device 600 may perform the following steps S610 to S670. In step S610, the bridge chip 500 may determine whether it is connected to the USB connection port of the computing device 600. If it is determined as "no", in step S620, the bridge chip 500 may confirm that the current status is connection failure or not yet connected to the computing device. If it is determined as "yes", in step S630, whether the USB bridge controller 521 supports the USB communication protocol for connection may be confirmed by the platform controller hub 620 of the computing device 600. If it is determined as "no", in step S640, the platform controller hub 620 may confirm that the current status is unable to use the specific communication protocol for connection. If it is determined as "yes", in step S650, the computing device 600 may initialize the bridge chip 500.

In step S660, the platform controller hub 620 of the computing device 600 may determine whether to perform data transmission with the artificial intelligence controller 510. In this embodiment, the platform controller hub 620 of the computing device 600 may determine whether high-speed data transmission with the artificial intelligence controller 510 is possible. If it is determined as "no", in step S640, the platform controller hub 620 of the computing device 600 may confirm that the current status is unable to use the specific communication protocol for connection. If it is determined as "yes", in step S670, data transmission may be performed between the bridge chip 500 and the computing device 600. In this embodiment, the bridge chip 500 and the computing device 600 may perform the transmission operation of the artificial intelligence computing data. Therefore, the bridge chip 500 and the operating method thereof of the present embodiment may perform a USB transmission operation through a single chip architecture integrating the artificial intelligence controller 510 and the USB bridge controller 521. Furthermore, since the artificial intelligence controller 510 and the USB bridge controller 521 are integrated into a single chip architecture, this effectively reduces the time required for the USB bridge controller 521 to connect to and identify the downstream artificial intelligence controller 510.

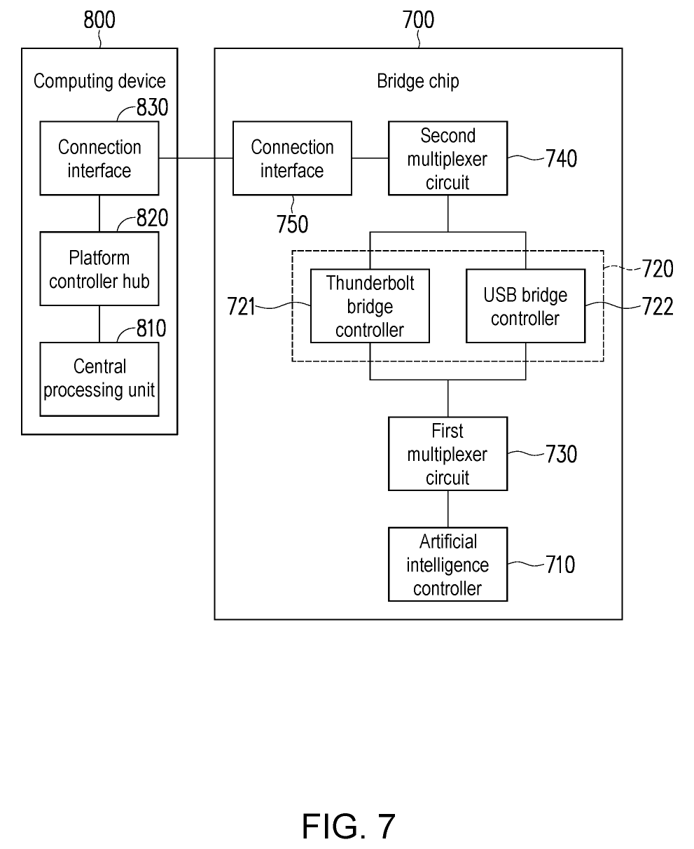

FIG. 7 is a schematic diagram of a bridge chip according to another embodiment of the disclosure. Referring to FIG. 7, the bridge chip of the disclosure may also implement the architecture shown in FIG. 7. In this embodiment, the bridge chip 700 includes an artificial intelligence controller 710, a bridge control circuit 720, a first multiplexer circuit 730, a second multiplexer circuit 740, and a connection interface 750. The first multiplexer circuit 730 and the second multiplexer circuit 740 may be an upstream multiplexer and a downstream multiplexer. In this embodiment, the bridge control circuit 720 includes a Thunderbolt bridge controller 721 and a USB bridge controller 722. The first multiplexer circuit 730 is coupled between the artificial intelligence controller 710 and the bridge control circuit 720. The second multiplexer circuit 740 is coupled between the bridge control circuit 720 and the connection interface 750, in which the connection interface 750 may include a Thunderbolt connector and a USB connector. The second multiplexer circuit 740 may be, for example, connected to the connection interface 830 of the computing device 800 through the Thunderbolt connector or the USB connector. The computing device 800 further includes a central processing unit 810 and a platform controller hub 820. The connection interface 830 may include at least one of a Thunderbolt connection port and a USB connection port.

In this embodiment, when the bridge chip 700 is connected to the Thunderbolt connection port of the computing device 800 through the Thunderbolt connector, the first multiplexer circuit 730 is switched to establish a communication channel between the artificial intelligence controller 710 and the Thunderbolt bridge controller 721, and the second multiplexer circuit 740 is switched to establish a communication channel between the Thunderbolt bridge controller 721 and the Thunderbolt connection port of the computing device 800.

In this embodiment, when the bridge chip 700 is connected to the USB connection port of the computing device 800 through the USB connector, the first multiplexer circuit 730 is switched to establish a communication channel between the artificial intelligence controller 710 and the USB bridge controller 722, and the second multiplexer circuit 740 is switched to establish a communication channel between the USB bridge controller 722 and the USB connection port of the computing device 800.

In other words, the artificial intelligence accelerator device equipped with the bridge chip 700 may be selectively connected to the Thunderbolt connection port or the USB connection port of the computing device through the Thunderbolt connector or the USB connector. Therefore, the artificial intelligence controller 710 may perform the transmission operation of the artificial intelligence computing data with the computing device 800 through one of the Thunderbolt bridge controller 721 and the USB bridge controller 722.

To sum up, the bridge chip and the operating method thereof of the disclosure may perform the transmission operation of artificial intelligence computing data through a single chip integrating an artificial intelligence controller and a bridge control circuit. The bridge control circuit includes at least one of a Thunderbolt connector and a USB connector. An artificial intelligence accelerator device equipped with the bridge chip of the disclosure may effectively optimize its device dimension, save component costs, reduce the circuit substrate layout area, and reduce the system design complexity. From another perspective, the artificial intelligence accelerator device equipped with the bridge chip of the disclosure supports computing devices with any connection interface. The artificial intelligence accelerator device equipped with the bridge chip of the disclosure may be arbitrarily connected to a computing device having at least one of a Thunderbolt connection port and a USB connection port to provide artificial intelligence computing acceleration functions to the computing device.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

What is claimed is:

1. A bridge chip, comprising:
an artificial intelligence controller; and
a bridge control circuit, coupled to the artificial intelligence controller,
wherein when the bridge chip is connected to a connection port of a computing device, whether the bridge control circuit supports a specific communication protocol for connection is confirmed by the computing device,
wherein when the computing device confirms that the bridge control circuit supports the specific communication protocol for connection, the bridge chip is initialized by the computing device, and the computing device determines whether to perform data transmission with the artificial intelligence controller.

2. The bridge chip according to claim 1, wherein the bridge control circuit comprises a Thunderbolt bridge controller, and the computing device comprises a Thunderbolt master controller, wherein when the Thunderbolt master controller determines that the bridge chip is connected to a Thunderbolt connection port of the computing device, whether the Thunderbolt bridge controller supports a Thunderbolt communication protocol for connection is confirmed by the Thunderbolt master controller.

3. The bridge chip according to claim 2, wherein the artificial intelligence controller is configured to perform a transmission operation of artificial intelligence computing data with the Thunderbolt master controller of the computing device through the Thunderbolt bridge controller.

4. The bridge chip according to claim 1, wherein the bridge control circuit comprises a universal serial bus (USB) bridge controller, and the computing device comprises a platform controller hub (PCH), wherein when the platform controller hub determines that the bridge chip is connected to a USB connection port of the computing device, whether the USB bridge controller supports a USB communication protocol for connection is confirmed by the platform controller hub.

5. The bridge chip according to claim 4, wherein the artificial intelligence controller is configured to perform a transmission operation of artificial intelligence computing data with the platform controller hub of the computing device through the USB bridge controller.

6. The bridge chip according to claim 1, further comprising:
a first multiplexer circuit, coupled to the bridge control circuit and the artificial intelligence controller; and
a second multiplexer circuit, coupled to the bridge control circuit,
wherein the bridge control circuit comprises a Thunderbolt bridge controller and a USB bridge controller, and the computing device comprises a Thunderbolt master controller and a platform controller hub.

7. The bridge chip according to claim 6, wherein when the bridge chip is connected to a Thunderbolt connection port of the computing device, the first multiplexer circuit is switched to establish a communication channel between the artificial intelligence controller and the Thunderbolt bridge controller, and the second multiplexer circuit is switched to establish a communication channel between the Thunderbolt bridge controller and the Thunderbolt connection port.

8. The bridge chip according to claim 6, wherein when the bridge chip is connected to a USB connection port of the computing device, the first multiplexer circuit is switched to establish a communication channel between the artificial intelligence controller and the USB bridge controller, and the second multiplexer circuit is switched to establish a communication channel between the USB bridge controller and the USB connection port.

9. The bridge chip according to claim 6, wherein the artificial intelligence controller is configured to perform a transmission operation of artificial intelligence computing data with the computing device through one of the Thunderbolt bridge controller and the USB bridge controller.

10. The bridge chip according to claim 1, wherein the bridge chip is disposed in an artificial intelligence accelerator device.

11. An operating method of a bridge chip, wherein the bridge chip comprises an artificial intelligence controller and a bridge control circuit, wherein the operating method comprises:
confirming whether the bridge control circuit supports a specific communication protocol for connection by a computing device when the bridge chip is connected to a connection port of the computing device; and
initializing the bridge chip by the computing device when the computing device confirms that the bridge control circuit supports the specific communication protocol for connection; and
determining whether to perform data transmission with the artificial intelligence controller through the computing device.

12. The operating method according to claim 11, wherein the bridge control circuit comprises a Thunderbolt bridge controller, and the computing device comprises a Thunderbolt master controller, wherein confirming whether the bridge control circuit supports the specific communication protocol for connection comprises:
confirming whether the Thunderbolt bridge controller supports a Thunderbolt communication protocol for connection by the Thunderbolt master controller when the Thunderbolt master controller determines that the bridge chip is connected to a Thunderbolt connection port of the computing device.

13. The operating method according to claim 12, wherein the artificial intelligence controller is configured to perform a transmission operation of artificial intelligence computing data with the Thunderbolt master controller of the computing device through the Thunderbolt bridge controller.

14. The operating method according to claim 11, wherein the bridge control circuit comprises a USB bridge controller, and the computing device comprises a platform controller hub, wherein confirming whether the bridge control circuit supports the specific communication protocol for connection comprises:
confirming whether the USB bridge controller supports a USB communication protocol for connection by the platform controller hub when the platform controller hub determines that the bridge chip is connected to a USB connection port of the computing device.

15. The operating method according to claim 14, wherein the artificial intelligence controller is configured to perform a transmission operation of artificial intelligence computing data with the platform controller hub of the computing device through the USB bridge controller.

16. The operating method according to claim 11, wherein the bridge chip further comprises a first multiplexer circuit and a second multiplexer circuit, the bridge control circuit comprises a Thunderbolt bridge controller and a USB bridge controller, and the computing device comprises a Thunderbolt master controller and a platform controller hub.

17. The operating method according to claim 16, further comprising:
establishing a communication channel between the artificial intelligence controller and the Thunderbolt bridge controller through switching the first multiplexer circuit when the bridge chip is connected to a Thunderbolt connection port of the computing device; and
establishing a communication channel between the Thunderbolt bridge controller and the Thunderbolt connection port through switching the second multiplexer circuit.

18. The operating method according to claim 16, further comprising:
establishing a communication channel between the artificial intelligence controller and the USB bridge controller through switching the first multiplexer circuit when the bridge chip is connected to a USB connection port of the computing device; and
establishing a communication channel between the USB bridge controller and the USB connection port through switching the second multiplexer circuit.

19. The operating method according to claim 16, wherein the artificial intelligence controller is configured to perform a transmission operation of artificial intelligence computing data with the computing device through one of the Thunderbolt bridge controller and the USB bridge controller.

20. The operating method according to claim 11, wherein the bridge chip is disposed in an artificial intelligence accelerator device.
